(19) United States
(12) Patent Application Publication
(10) Pub. No.: US 2026/0210452 A1
(43) Pub. Date: Jul. 23, 2026

(54) METHOD, PROCESS VALVE, VALVE ASSEMBLY

(71) Applicant: GEMÜ Gebr. Miller Apparatebau GmbH & Co. Kommanditgesellschaft, Ingelfingen (DE)

(72) Inventors: Christian DASBACH, Heilbronn (DE); Michael Baumgartner, Dörzbach (DE); Ota Vojacek, Ähus (SE); Matthias Fink, Künzelsau (DE)

(21) Appl. No.: 19/138,089

(22) PCT Filed: Sep. 18, 2023
(86) PCT No.: PCT/EP2023/075630

§ 371 Date: Jun. 11, 2025

(30) Foreign Application Priority Data
Dec. 12, 2022 (DE) 10 2022 132 929.1
Dec. 12, 2022 (DE) 10 2022 132 932.1
Dec. 12, 2022 (DE) 10 2022 132 934.8

(51) Int. Cl. F16K 11/22; B33Y 80/00; F16K 7/04; F16K 7/12; F16K 27/02

(52) U.S. Cl. CPC F16K 11/22; F16K 7/04; F16K 7/123; F16K 27/0236; B33Y 80/00

(57) ABSTRACT

An inner body for controlling a process fluid is provided. The inner body is configured to be detachably arranged within an outer body and includes at least one valve portion disposed along an imaginary flow path between at least two process fluid ports. The valve portion includes a seat portion that is stationary during operation and defines a seat surface delimiting an interior of the inner body, and an obstruction portion positioned opposite the seat portion. The obstruction portion includes an obstruction surface delimiting the interior and is movable, at least in part and during operation, along an imaginary adjustment axis toward and away from the seat surface.

### DESCRIPTION

The invention relates to a method for producing an inner body of a process valve or a valve assembly, and to a process valve or valve assembly, an inner body for a process valve, the process valve and a valve assembly, and to a valve assembly and a method for replacing an inner body of the valve assembly.

The problems of the prior art are solved by: a method according to claim 1 and a process valve or valve assembly according to a further claim, an inner body according to a further independent claim and a process valve or valve assembly according to a further claim, along with a valve assembly according to an independent claim and by a method according to a further claim.

One aspect of the description relates to the following subject matter: a method for producing an inner body comprising: assembling, layer by layer, at least one portion of the inner body according to a digital 3D model of the inner body from at least one material.

The additive manufacturing of the inner body not only makes possible a high geometric complexity of the interior in order to reduce dead spaces, but also a high integration density of valve functions by means of a plurality of closely spaced valve portions. The effort required to produce tools and change tools is eliminated, and the possibilities for adapting to customer requirements are increased.

For example, it is advantageous that the assembling, layer by layer, further comprises: assembling, layer by layer, at least one or a plurality of valve portions, in each case comprising a seat portion that is stationary at least during operation and an obstruction portion that is integrally connected to the seat portion and opposite the seat portion, wherein the obstruction portion is movable towards and away from the seat portion along an adjustment axis at least during operation, in order to change the flow of the process fluid through the valve portion.

Depending on customer requirements, different valve types can be advantageously realized with different geometries of the seat portion and the assigned obstruction portion.

For example, it is advantageous that the assembling, layer by layer, further comprises: assembling, layer by layer, at least one connecting portion delimiting the interior and that connects at least two valve portions to one another or that integrally connects a valve portion and a process fluid port to one another.

Advantageously, the inner body is manufactured to a large extent or entirely as an integral part, which results in a degree of design freedom, in particular at transitions between different regions of the inner body.

For example, it is advantageous that the assembling, layer by layer, comprises: assembling, layer by layer, an intermediate portion that connects the seat portion to the movable obstruction portion, wherein the seat portion, the obstruction portion and the intermediate portion delimit the common interior with their corresponding inner surface.

The intermediate portion advantageously connects the obstruction portion integrally with the seat portion.

It is advantageous, for example, that the assembling, layer by layer, comprises: assembling, layer by layer, at least one support portion, which adjoins the seat portion on the outside, from a secondary material, which, in the manufactured state, has an increased modulus of elasticity relative to a primary material for the seat portion.

This advantageously provides a soft-sealing valve portion, which is stabilized by the support portion arranged behind it. In other words, the support portion forms a rather rigid counter-bearing to the obstruction portion. Furthermore, a space between the seat portion and the outer body is filled, which simplifies the assembly in the outer body.

Advantages arise from the fact that the assembling, layer by layer, further comprises: assembling, layer by layer, a removable support contour, which, after production of the inner body, is located in particular within an interior of the inner body, and consists of a further, in particular washable, material; and wherein the method comprises, after the assembling, layer by layer: removing the support contour from the inner body, in particular by rinsing the inner body with a liquid.

Complex inner contours of the inner body are only made possible by the removable support contour.

For example, it is advantageous that the method further comprises: producing a plurality of connecting portions, which delimit the interior of the inner body in portions; and multiple joining, at least joining in pairs, in particular welding, in particular laser welding, the plurality of valve portions and the plurality of connecting portions to the inner body.

Due to the multi-part production method, for example, individual injection-molded elements in the sense of connecting portions can be connected with 3D-printed components in the sense of valve portions. This provides a modular system in order to manufacture individual inner bodies.

It is advantageous, e.g., that the assembling, layer by layer, comprises: assembling, layer by layer, a connecting portion of at least one process fluid port made of a secondary material for connecting a further fluid line; assembling, layer by layer, an inner portion of the at least one process fluid port, wherein the connecting portion is fixed at least in a form-fitting manner, in particular additionally in a material-fitting manner, to an inner portion of the process fluid port delimiting the interior, wherein the inner portion delimiting the interior is manufactured from a primary material that is different from the secondary material and is also used, for example, in the obstruction portion.

Advantageously, optimized materials can be used for the connecting portion, which, in contrast to the portion delimiting the interior, do not have to be designed for media contact. This results in degrees of freedom that lead to an improved connection of the inner body to other fluid lines.

For example, it is advantageous that the secondary material has an increased modulus of elasticity relative to the primary material.

As a result, the fastening capability of the process fluid port is advantageously increased.

Advantages arise from the fact that the assembling, layer by layer, comprises: assembling, layer by layer, the seat portion with the seat surface, which delimits an inner fluid opening, which can be closed by means of the obstruction surface that can be pressed onto the seat surface, wherein the seat surface and the obstruction surface of the at least one valve portion are in each case formed rotationally symmetrically to the adjustment axis.

As a result, channel portions that meet at a 90° angle, for example, can be advantageously connected.

For example, it is advantageous that the assembling, layer by layer, comprises: assembling, layer by layer, the obstruction portion, which extends in its longitudinal extent along the adjustment axis and is connected, facing away from the seat portion, to a flex portion that is provided for a recurring deformation in the sense of flexing, and assembling, layer by layer, the flex portion, wherein the flex portion connects the obstruction portion integrally and movably to the remaining inner body along the adjustment axis.

For example, it is advantageous that the assembling, layer by layer, comprises: assembling, layer by layer, a compressor that is manufactured in particular from the secondary material, has a higher modulus of elasticity than the obstruction portion, and is arranged on the dry side, at least in portions, within the obstruction portion.

As a result, the force originating from the drive can advantageously be introduced uniformly from the obstruction surface into the seat surface.

It is advantageous, for example, that the obstruction portion tapers away from the seat portion at least in portions, wherein the flex portion adjoins the taper.

Due to the taper of the obstruction portion in the direction of the flex portion, the volume of the interior increases in such a way that the obstruction portion, facing away from the seat portion, is increasingly circulated by process fluid. As a result, the flow conditions when closing and opening the valve portion are improved.

It is advantageous, for example, that the flex portion is rotationally symmetrical to the adjustment axis.

The rotationally symmetrical design has advantages both with respect to the flex and movement properties, for example an extended service life, as well as properties that positively influence the fluid flow, such as a reduction in dead space and an improved, more even distribution of the fluid pressure in the region of the seat surface or seat opening.

It is advantageous, for example, that the obstruction portion is designed in a projection-like manner, protrudes into a working space of the valve portion and is arranged so as to be movable along the adjustment axis within the working space of the valve portion.

Advantageously, the obstruction portion is surrounded by process fluid, which has advantageous effects on the flow conditions within the valve portion.

It is advantageous, e.g., that the assembling, layer by layer, comprises: assembling, layer by layer, the seat portion, wherein the clear interior widens at least in portions, in particular continuously, in a first longitudinal section perpendicular to the adjustment axis towards the seat portion, and wherein the clear interior tapers at least in portions, in particular continuously, in a second longitudinal section, in which the adjustment axis runs, towards the seat portion.

Advantageously, a sufficiently large inner cross section is released in the open state, which does not impede the flow of the process fluid.

For example, it is advantageous that the assembling, layer by layer, comprises: assembling, layer by layer, the flexible obstruction portion; assembling, layer by layer, a holding portion of the inner body that is rather rigid compared to the obstruction portion, wherein the flexible obstruction portion is held on the holding portion, and wherein the modulus of elasticity of the obstruction portion is smaller than the modulus of elasticity of the holding portion.

Advantageously, the flexibility for moving the obstruction portion is increased. The rather rigid holding portion improved handling when changing the inner body.

One example is characterized in that, at least in an open state of the at least one valve portion, the seat surface and the obstruction surface, in particular perpendicular to the imaginary flow path, delimit a clear inner cross section that is larger perpendicular to the adjustment axis than along the adjustment axis.

It arises from this that the seat surface and the obstruction surface are opposite one another in their particular course in order to be able to close the valve portion more effectively.

It is advantageous that the corresponding course of the seat surface and the obstruction surface runs in a web-like manner and in an imaginary plane encompassing the adjustment axis.

As a result, the valve portion is advantageously closed in a defined, web-like portion perpendicular to the fluid path.

One aspect of the description relates to the following subject matter: a process valve or valve assembly comprising the inner body, which is produced according to the method according to one of the previous aspects, and a rigid multi-part outer body, wherein the rigid outer body has a counter-contour to an outer contour of the inner body, wherein the inner body is received in the counter-contour in a form-fitting manner, wherein at least one drive is arranged rigidly on the outer body, and wherein a drive rod of the at least one drive, which drive rod is movable along the adjustment axis, protrudes through an assigned adjustment opening of the outer body and is connected in a force-transmitting manner to the obstruction portion of the assigned at least one valve portion of the inner body.

One aspect of the description relates to an inner body for controlling a process fluid and for the detachable assembly in an outer body, wherein the inner body comprises at least one valve portion that is arranged along an imaginary flow path between at least two process fluid ports of the inner body, wherein the valve portion comprises: a seat portion that is stationary at least during operation and has a seat surface delimiting an interior of the inner body; and an obstruction portion that is connected to the seat portion and opposite the seat portion and has an obstruction surface delimiting the interior of the inner body, wherein the obstruction portion is movable, at least during operation, at least in portions along an imaginary adjustment axis towards the seat surface and away from the seat surface.

As a result, single-use applications with a valve function can be realized, in which the inner body containing the valve portion is replaced as a whole. Another advantage is that the number of sealing points to the outside is reduced, such as the sealing point between the valve part and the diaphragm that is common in diaphragm valves. The tightness to the outside is thus improved. The number of required components and thus the complexity of the process valve is reduced.

For example, it is advantageous that the valve portion comprises an intermediate portion that connects the seat portion to the movable obstruction portion, and that the seat portion, the obstruction portion and the intermediate portion delimit the common interior with their corresponding inner surface.

For example, it is advantageous that a wall of the inner body, the surface of which delimits the interior, is manufactured entirely from a single material.

An advantageous result is that this not only simplifies the certification of the inner body. Unwanted material abrasion and entry into the process medium is thus reduced or prevented. Such an inner body is suitable for high-purity applications in medicine and biology.

An advantageous example is characterized in that at least the seat surface and in particular the obstruction surface of the at least one valve portion deviate from a shape of an imaginary cylinder jacket, which in particular is followed by a portion adjacent to the valve portion.

Advantageously, complex shaped valve portions with a desired flow behavior can be realized.

For example, it is advantageous that the inner body comprises at least one support portion, which adjoins the seat portion towards the outside and which has an increased modulus of elasticity relative to the seat portion.

This advantageously provides a soft-sealing valve portion, which is stabilized by the support portion. In other words, the support portion forms a rather rigid counter-bearing to the obstruction portion. Furthermore, a space between the seat portion and the outer body is filled, which simplifies the assembly in the outer body.

Advantages arise from the fact that an outwardly facing recess, which delimits the seat portion, is closed with the support portion.

This not only advantageously makes possible a simplified assembly of the inner body in the outer body by avoiding acute angles in the outer contour of the inner body.

For example, it is advantageous that the obstruction portion has a dry-side coupling portion for force-transmitting connection with a drive-side counter-coupling portion.

An example is characterized in that at least one of the process fluid ports comprises a connecting portion made of a secondary material for connecting a further fluid line, wherein the connecting portion is fixed at least in a form-fitting manner, in particular additionally in a material-fitting manner, to an inner portion of the process fluid port delimiting the interior, wherein the inner portion delimiting the interior is manufactured from a primary material different from the secondary material and having a reduced modulus of elasticity than the primary material.

Advantageously, optimized materials can be used for the connecting portion, which, in contrast to the portion delimiting the interior, do not have to be designed for media contact. This results in degrees of freedom that contribute to an improved connection of the inner body to other fluid lines.

It is advantageous, for example, that the seat surface delimits an inner fluid opening, which can be closed by means of the obstruction surface that can be pressed onto the seat surface.

As a result, channel portions that meet at a 90° angle, for example, can be advantageously connected.

It is advantageous, for example, that the seat surface and the obstruction surface of the at least one valve portion are in each case rotationally symmetrical or rotationally symmetrical to the adjustment axis.

It is advantageous, for example, that the obstruction portion extends in its longitudinal extent along the adjustment axis and, facing away from the seat portion, is connected to a flex portion, wherein the flex portion connects the obstruction portion along the adjustment axis in a movable and integral manner with the remaining inner body.

Advantages are achieved in that the obstruction portion is designed in a projection-like manner, protrudes into a working space of the valve portion and is arranged so as to be movable along the adjustment axis within the working space of the valve portion.

Advantageously, the obstruction portion is surrounded by process fluid, which has advantageous effects on the flow conditions in the working space.

For example, it is advantageous that a compressor, which has a higher modulus of elasticity than the obstruction portion, is arranged on the dry side, at least in portions, within the obstruction portion.

As a result, the force originating from the drive is evenly introduced across the obstruction surface into the seat surface

For example, it is advantageous that a support portion rigidly connected to the dry-side coupling portion supports the flex portion in at least one position of the obstruction portion along the adjustment axis.

The flexing or rolling movement is advantageously supported in that the media pressure has the support portion as a counter-bearing.

Advantages arise from the fact that the obstruction portion tapers away from the seat portion at least in portions, wherein the flex portion adjoins the taper.

Due to the taper of the obstruction portion in the direction of the flex portion, the volume of the interior increases in such a way that the obstruction portion, facing away from the seat portion, is circulated by process fluid. As a result, the flow conditions in the working space are improved in every movement state of the obstruction portion.

For example, it is advantageous that the flex portion is rotationally symmetrical to the adjustment axis.

The rotationally symmetrical design has advantages both with respect to the flex and movement properties, for example an extended service life, as well as properties that positively influence the fluid flow, such as a reduction in dead space.

It is advantageous that, at least in an open state of the at least one valve portion, the seat surface and the obstruction surface, in particular perpendicular to the imaginary flow path, delimit a clear inner cross section that is larger perpendicular to the adjustment axis than along the adjustment axis.

It arises from this that the seat surface and the obstruction surface are opposite one another in their particular course in order to be able to close the valve portion more effectively.

For example, it is advantageous that, at least in an open state of the at least one valve portion, the seat surface and the obstruction surface of the at least one valve portion run convexly, at least in portions, in a section perpendicular to the imaginary flow path.

Advantageously, a sufficiently large inner cross section is released in the open state, which does not impede the flow of the process fluid.

It is advantageous, for example, that the corresponding course of the seat surface and the obstruction surface is web-like and follows an imaginary plane encompassing the adjustment axis.

As a result, the valve portion is advantageously closed in a defined, web-like portion perpendicular to the fluid path.

It is advantageous, for example, that the clear interior widens at least in portions, in particular continuously, in a first longitudinal section perpendicular to the adjustment axis towards the seat portion, and wherein the clear interior tapers at least in portions, in particular continuously, in a second longitudinal section, in which the adjustment axis runs, towards the seat portion.

For example, it is advantageous that the flexible obstruction portion is held on a holding portion of the inner body, which is rigid, in particular less flexible, compared to the obstruction portion.

Advantageously, the flexibility for moving the obstruction portion is increased. The rather rigid holding portion improves handling when changing the inner body.

It is advantageous that the seat portion with its outer surface is recessed relative to an imaginary plane that abuts tangentially against the portions adjacent to the valve portion, for example process fluid ports.

Advantageously, the seat surface is located close to the movable obstruction portion.

For example, it is advantageous that the inner body comprises: a plurality of valve portions having the corresponding seat portion that is stationary at least during operation and having the obstruction portion that is integrally connected to the seat portion and opposite the seat portion, wherein the corresponding obstruction portion is movable, at least during operation, towards and away from the seat portion along an adjustment axis, in order to change the flow of the process fluid through the valve portion; and a plurality of connecting portions, wherein the plurality of valve portions and the plurality of connecting portions are at least partially connected to one another in pairs.

For example, it is advantageous that the interior is closed and is accessible exclusively via the at least two process fluid ports for supplying or discharging process fluid.

One aspect of the description relates to the following subject matter: a process valve or valve assembly comprising the inner body according to one of the preceding aspects and a rigid multi-part outer body, wherein the rigid outer body has a counter-contour to an outer contour of the inner body, wherein the inner body is received in the counter-contour in a form-fitting manner, wherein at least one drive is arranged rigidly on the outer body, and wherein a drive rod of the at least one drive, which drive rod is movable along the adjustment axis, protrudes through an assigned adjustment opening of the outer body and is connected in a force-transmitting manner to the obstruction portion of the assigned at least one valve portion of the inner body.

The outer body, which can also be referred to as an outliner, can be opened in order to replace the inner body, which can also be referred to as an inliner, thus ensuring quick replacement for single-use applications. The inliner serves as an insulator for the process medium, while the outliner acts as a counter-bearing for the fluid pressure and is responsible for fixing the inliner with respect to the drive.

One aspect of the description relates to a valve assembly comprising an inner body having at least one first coupling portion, which is connected in a force-transmitting manner to an obstruction portion of a valve portion of the inner body; an outer body designed for receiving the inner body and having at least one drive rigidly fastened to the outer body, wherein at least one second coupling portion is arranged on a drive rod of the drive.

It is advantageous, for example, that the first coupling portion is designed as a dry-side projection of the inner body delimiting a dry-side undercut of the inner body, wherein the second coupling portion is designed as a counter-coupling portion rigidly connected to the drive rod, wherein the projection is designed to snap into a corresponding recess of the counter-coupling portion when the counter-coupling portion is advanced.

This advantageously creates a simple system for coupling the obstruction portion having the drive, which can operate without any additional outer mechanics.

An advantageous example is characterized in that the projection is designed to be elastic, and wherein the recess is designed to be rigid.

As a result, the elastic property of the obstruction portion can be transferred to the projection, which can easily snap into the recess due to the elastic property.

For example, it is advantageous that the projection is designed to be axially symmetrical or rotationally symmetrical.

Advantageously, the connection region between the obstruction portion and the drive rod can be made small.

An advantageous example is characterized by the projection extending longitudinally perpendicular to the adjustment axis.

As a result, the force into the obstruction portion over a larger surface is advantageously introduced.

For example, it is advantageous that the projection tapers along its longitudinal extent towards the adjustment axis.

Due to this taper, the coupling having the compressor or the counter-coupling portion is advantageously influenced.

An advantageous example is characterized in that a locking element movably arranged within the outer body releases the movement of the first and second coupling portions in an assembly position, and in that the locking element connects the first and second coupling portions to one another in a force-transmitting manner in an operating position different from the assembly position.

Thus, a simple type of quick-lock mechanism is provided in order to establish a force-transmitting connection between the drive arranged on the outer body and the obstruction portion of the inner body.

It is advantageous, for example, that the outer body provides a receiving space in which the locking element is fixed in the outer body so as to be displaceable perpendicular to the adjustment axis.

Due to this assembly, the valve assembly is made small along the adjustment axis. Thus, only a slightly larger installation space is required to realize the locking and unlocking actions.

It is advantageous, for example, that at least one locking contour of the locking element, in the operating position of the locking element, presses the first coupling portion, at least in portions, into the assigned second coupling portion, which is designed in portions as an annular groove.

Due to such a perpendicular insertion of the first coupling portion into the second coupling portion, the coupling is realized in a simple manner.

It is advantageous, for example, that at least one release contour of the locking element releases an outer contour of the first coupling portion in the assembly position of the locking element, so that the first coupling portion moves out of the second coupling portion.

Thus, the decoupling is realized by a simple displacement movement of the locking element.

It is advantageous, for example, that the locking element has a locking surface by means of which the locking element is displaceable into its operating position.

By introducing force by means of a hand tool, such as a screwdriver, into the locking surface, the locking element is displaced, thereby providing a locking action that is easy to perform.

For example, it is advantageous that the locking element has an unlocking surface by means of which the locking element is displaceable into its assembly position.

By introducing force by means of a hand tool, such as a screwdriver, onto the unlocking surface, an unlocking action that is easy to perform is provided.

It is advantageous that the inner body has a plurality of first coupling portions that are connected in a force-transmitting manner to the corresponding obstruction portion of the corresponding valve portion of the inner body; and wherein the outer body comprises a plurality of drives rigidly fastened to the outer body, wherein a plurality of the second coupling portions are arranged on a corresponding drive rod of each of the plurality of drives, wherein a locking element movably arranged within the outer body in an assembly position releases the movement of the first and second coupling portions assigned in pairs to the corresponding valve portion, and wherein the locking element, in an operating position different from the assembly position, connects to one another in a force-transmitting manner the first and second coupling portions, which are assigned in pairs to the corresponding valve portion.

Advantageously, a plurality of obstruction portions can be simultaneously connected to and separated from the assigned drives in a force-transmitting manner.

For example, it is advantageous that the locking element is manufactured additively with the outer body.

Advantageously, the locking element is arranged in a captive manner in the outer body.

For example, it is advantageous that the plurality of drives are rigidly arranged on a first half-shell of the outer body, and that a second half-shell of the outer body, which in particular does not comprise any drives, i.e., is drive-free, together with the first half-shell delimits an inner contour for the form-fitting reception of the inner body.

Thus, advantageously, the inner body can be easily fixed and replaced.

Advantages arise from the fact that the second half-shell is fastened in a captive manner to the first half-shell via a hinge portion.

The captive assembly advantageously facilitates the assembly of the inner body.

One aspect of the description relates to the following subject matter: a method for exchanging a first inner body for a second inner body within the valve assembly according to one of the preceding aspects, the method comprising: opening the multi-part outer body; moving the locking element into the assembly position for simultaneously unlocking the first and second coupling portions, which are assigned in pairs; removing the first inner body from the outer body; arranging the second inner body in the open outer body; moving the locking element into the operating position for locking the first and second coupling portions, which are assigned in pairs. In the following description of the figures, the same reference signs are used for features even in different embodiments and across the figures. Furthermore, indices such as a, b, c, in the figures and in the description of the figures indicate the presence of a plurality of features of the same type. If this index a, b, c, is not present, the reference sign without an index nevertheless refers, both individually and collectively, to the elements with an index in the figure. In the drawing:

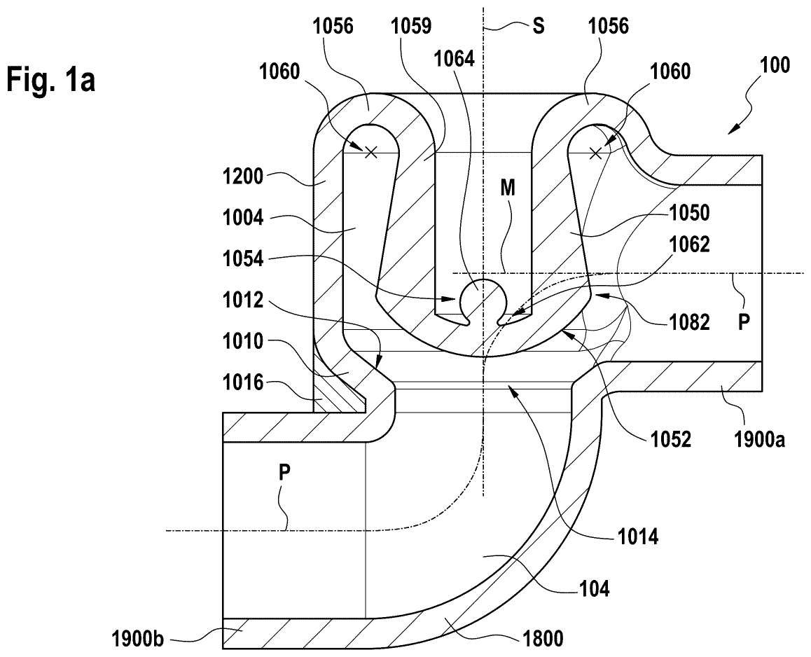

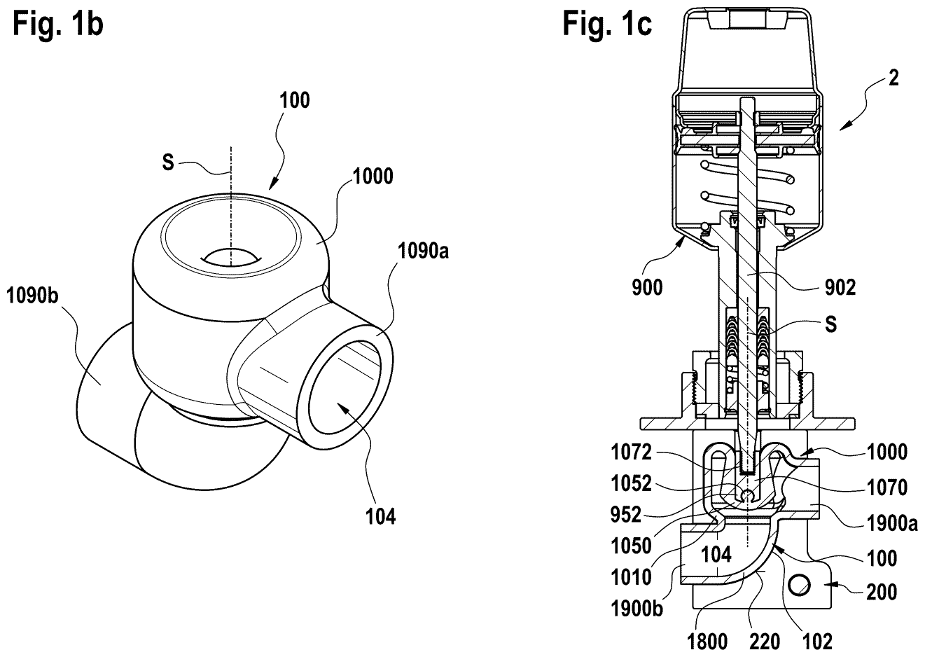

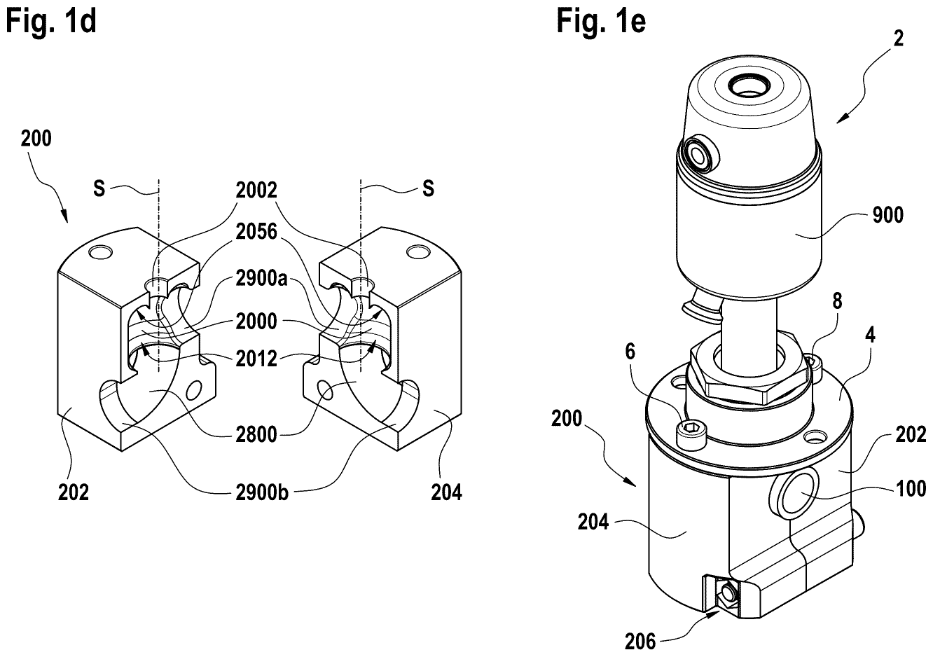

FIG. 1a is a section along a fluid path of a first example of an inner body;

FIG. 1b is a perspective view of the inner body from FIG. 1a;

FIG. 1c shows a first example of a valve with the inner body from FIGS. 1a and 1b;

FIG. 1d shows a first example of a two-part outer body for the valve from FIG. 1c;

FIG. 1e is a perspective view of the valve from FIG. 1c;

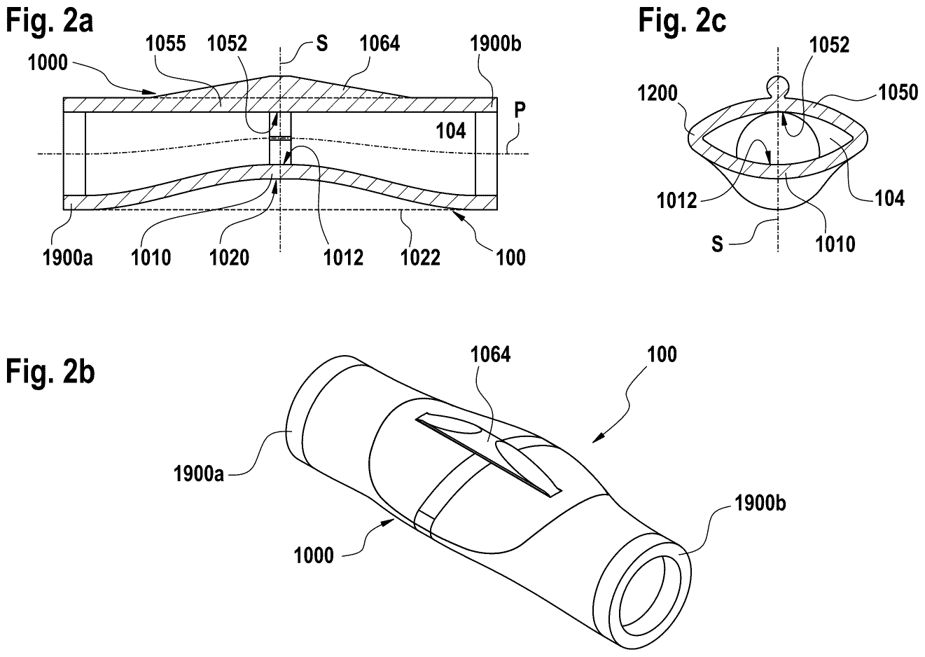

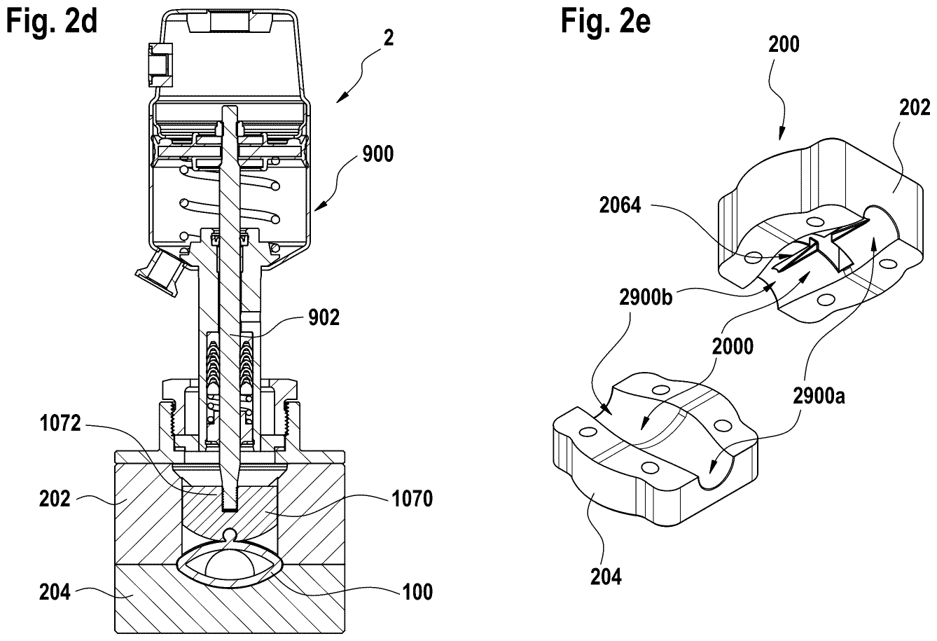

FIG. 2a shows a second example of the inner body in a section along the fluid path;

FIG. 2b is a perspective view of the inner body from FIG. 2a;

FIG. 2c is a section perpendicular to the fluid path of the inner body from FIG. 2a;

FIG. 2d shows a second example of a valve with the inner body of FIG. 2a;

FIG. 2e shows a second example of the two-part outer body for the valve from FIG. 2d;

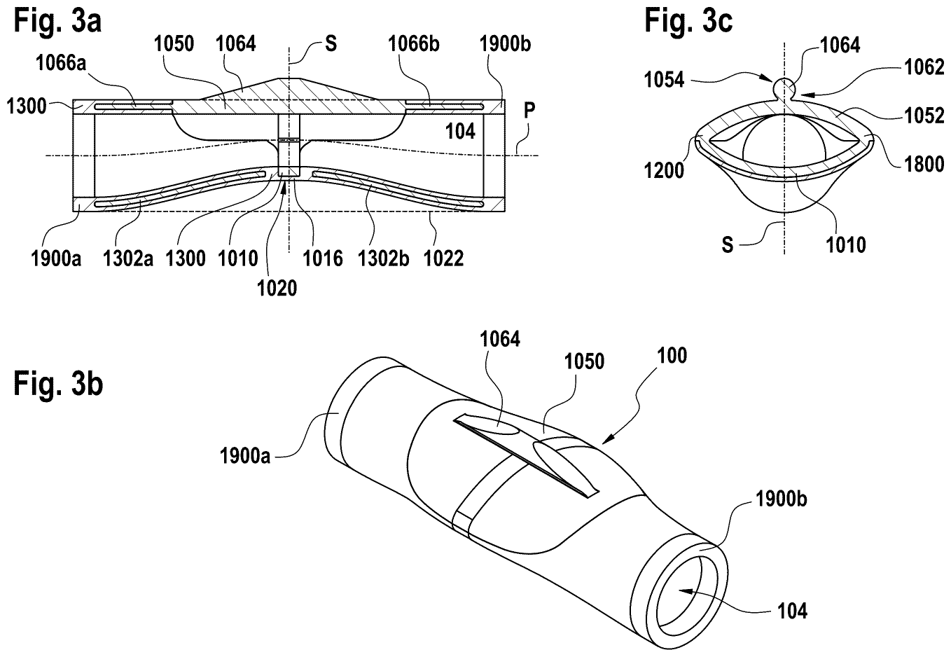

FIG. 3a is a section along the fluid path of a third example of the inner body, wherein the inner body can be inserted into the valve from FIG. 2d;

FIG. 3b is a perspective view of the inner body from FIG. 3a;

FIG. 3c is a section perpendicular to the fluid path of the inner body from FIG. 3a;

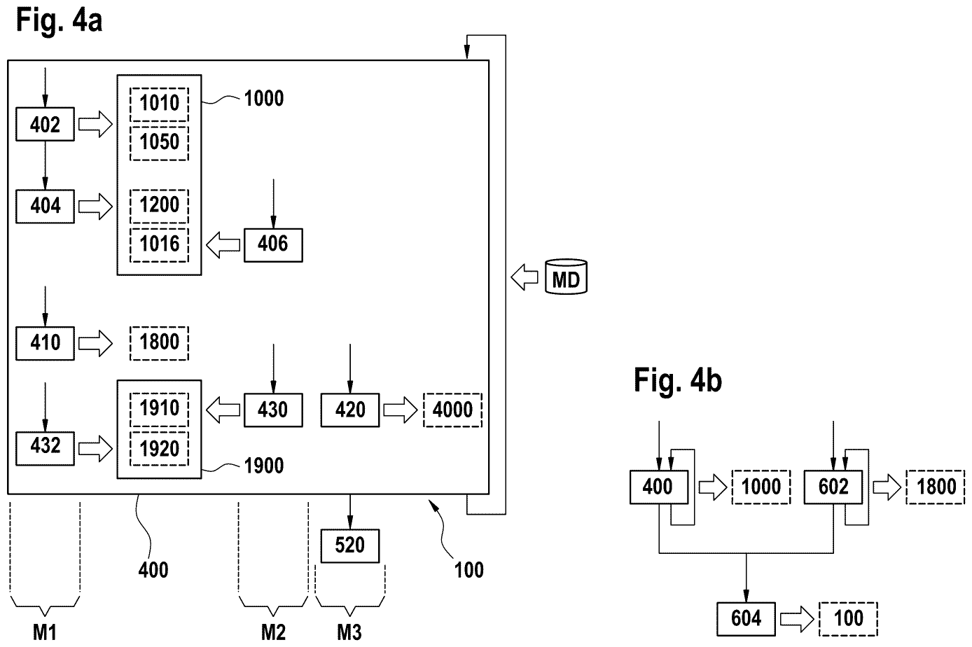

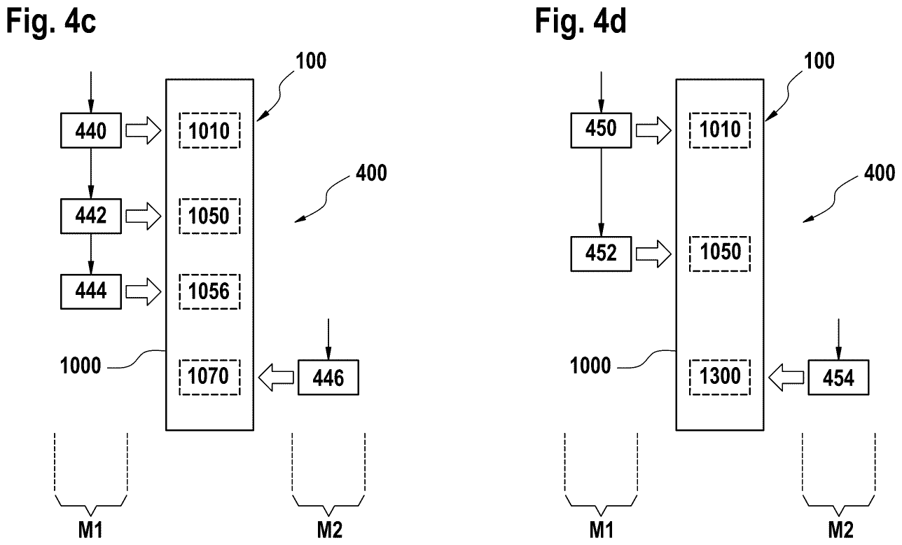

FIG. 4a is a schematic flow diagram for producing the inner body;

FIG. 4b is a schematic flow diagram for producing a partially joined inner body;

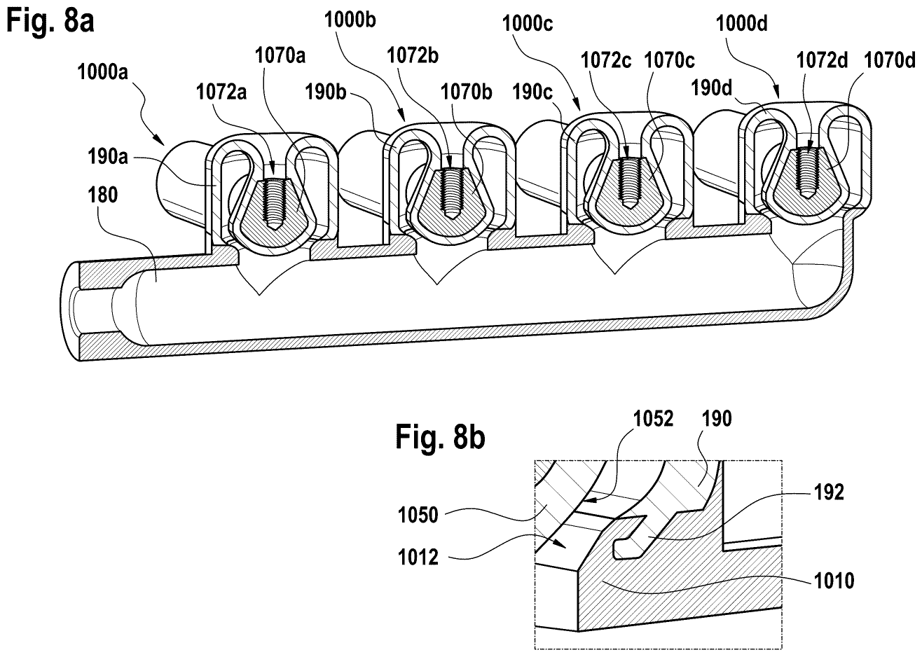

FIG. 4c is a schematic flow diagram for producing the inner body according to one of FIGS. 8a, 9a, 9b, 11a and 11c;

FIG. 4d is a schematic flow diagram for producing the inner body according to one of FIG. 3a-c;

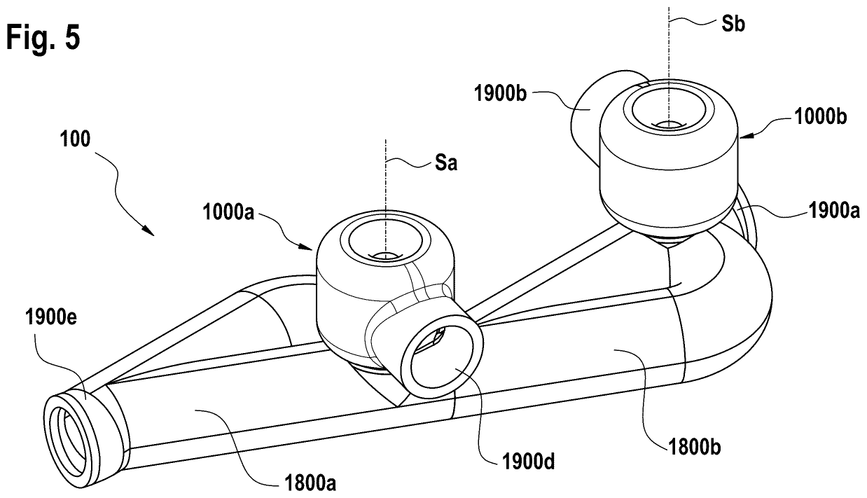

FIG. 5 is a perspective view of a fourth example of the inner body as a Tesla valve;

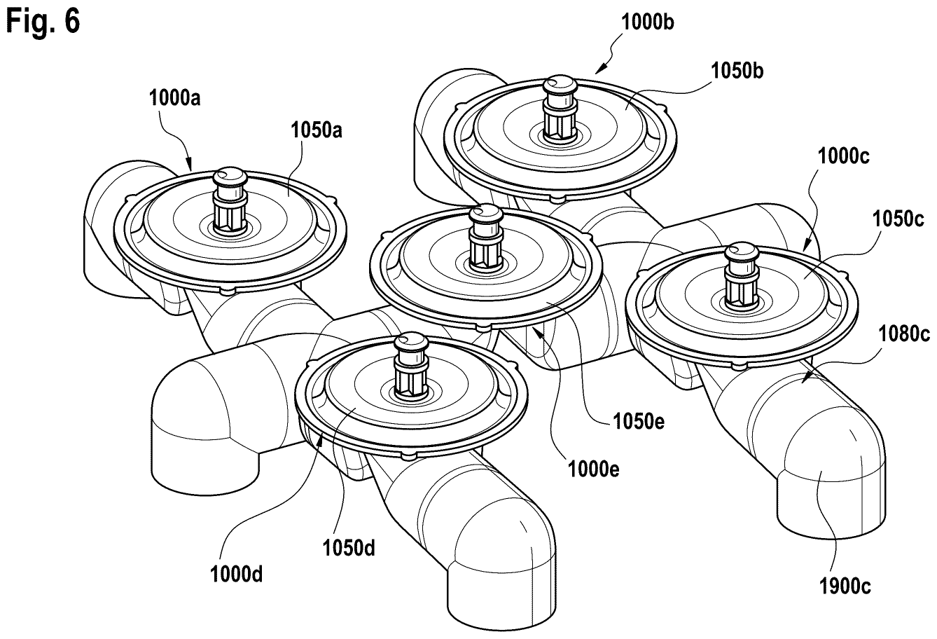

FIG. 6 shows a fifth example of the inner body with diaphragm valve-like obstruction portions;

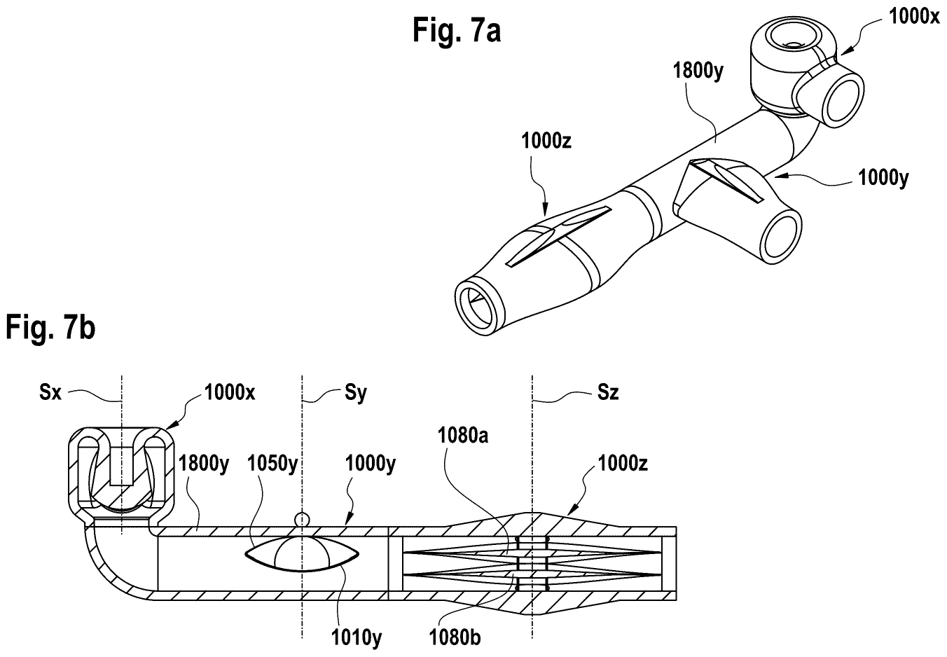

FIG. 7a is a perspective view of a sixth example of the inner body;

FIG. 7b is a sectional view of the inner body from FIG. 7b;

FIG. 8a is a perspective sectional view of a seventh example of the inner body;

FIG. 8b shows a detail from FIG. 8a;

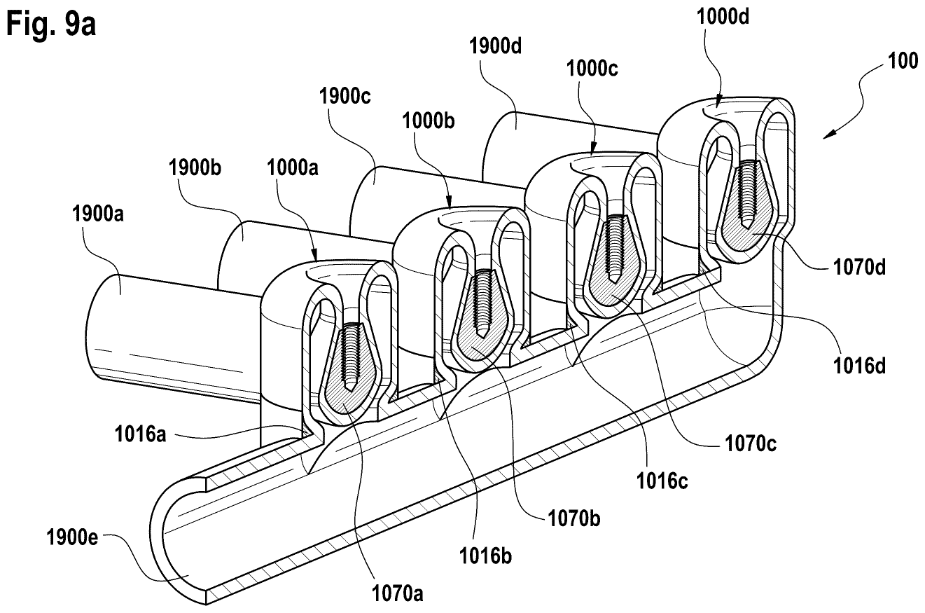

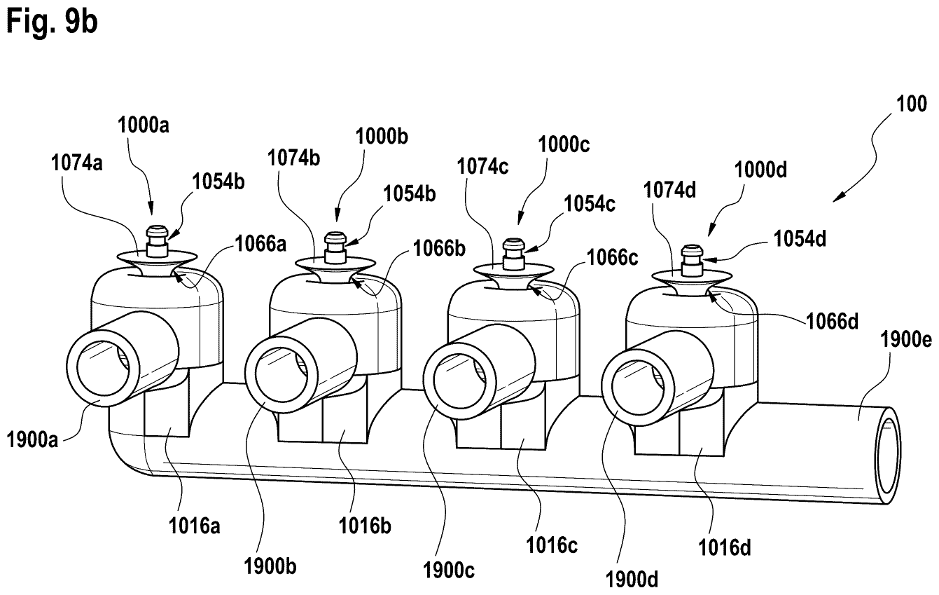

FIG. 9a is a perspective sectional view of an eighth example of the inner body;

FIG. 9b is a perspective view of the inner body from FIG. 9a;

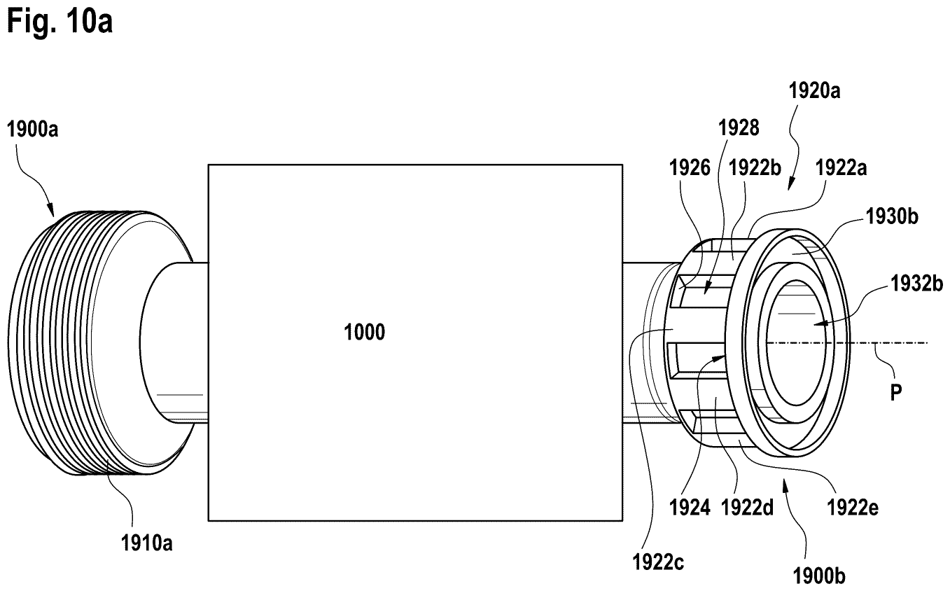

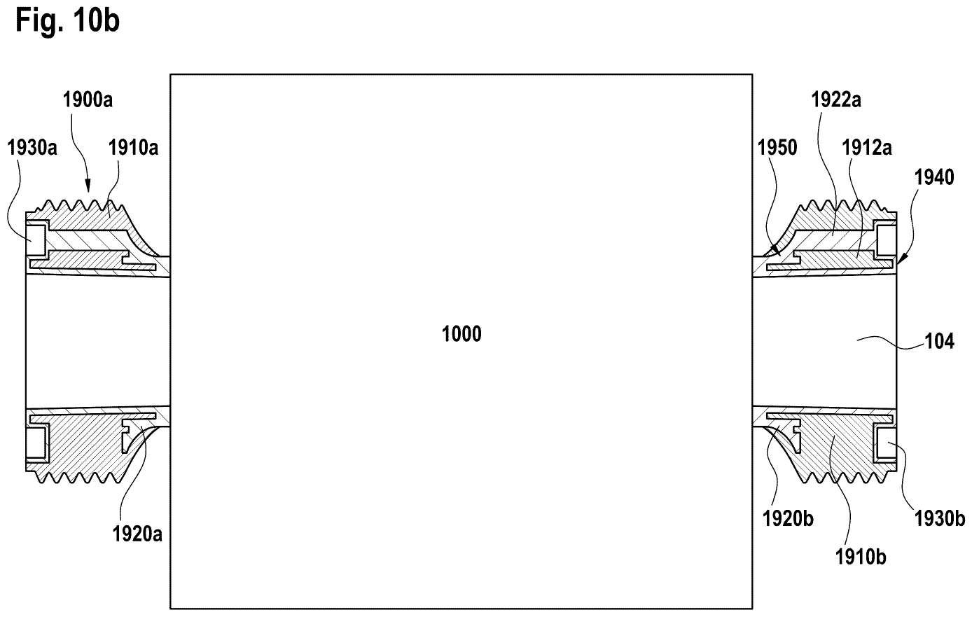

FIG. 10a shows an example of a process fluid port of the inner body;

FIG. 10b is a sectional view of process fluid ports;

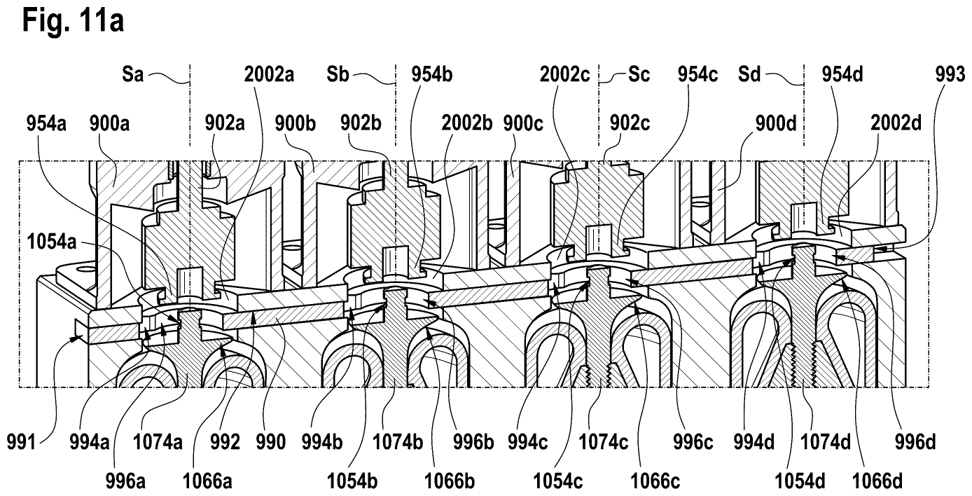

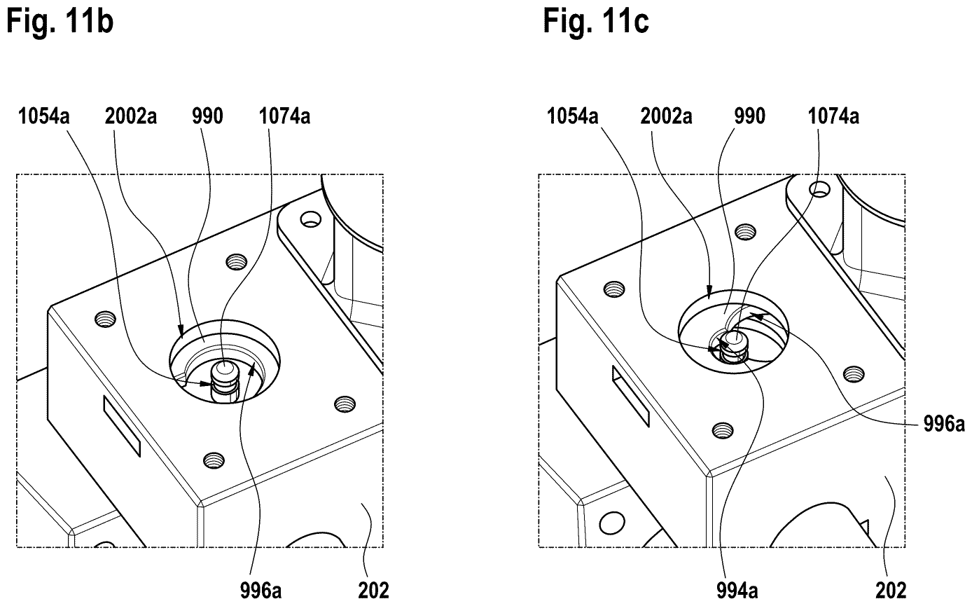

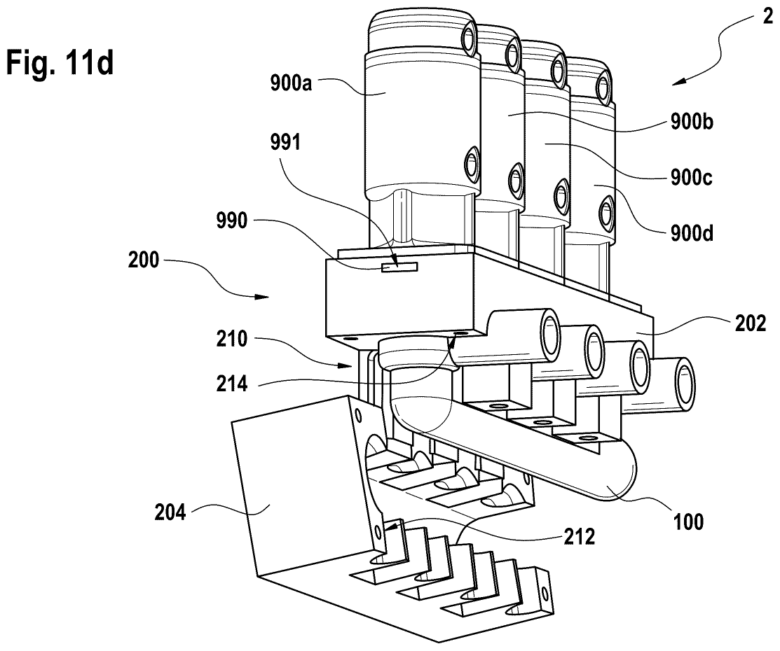

FIG. 11a is a perspective section of an example of a valve assembly;

FIG. 11b is a perspective top view of a coupling element of the valve assembly from FIG. 11a in an assembly position;

FIG. 11c is a perspective top view of the coupling element of the valve assembly from FIG. 11b in an operating position; and

FIG. 11d shows the valve assembly from FIG. 11a with the outer body open.

FIGS. 1a, 2a and 3a in each case show a longitudinal section of an inner body 100 for a valve, wherein the inner body 100 is provided for controlling a process fluid and for detachable assembly in an outer body 200. The inner body 100 comprises at least one valve portion 1000, which is arranged along an imaginary flow path P between at least two process fluid ports 1900 of the inner body 100. It is shown that the interior 104 is completely closed by means of a wall and is accessible exclusively via the at least two process fluid ports 1900 for supplying or discharging process fluid.

The valve portion 1000 comprises: a seat portion 1010 that is stationary at least during operation and has a seat surface 1012 delimiting the interior 104 of the inner body 100; and an obstruction portion 1050 that is integrally connected to the seat portion 1010 and opposite the seat portion 1010 having an obstruction surface 1052 delimiting the interior 104 of the inner body 100, wherein the obstruction portion 1050 is movable towards the seat surface 1012 and away from the seat surface 1012, at least during operation, along or parallel to an imaginary adjustment axis S, in the example of FIGS. 2a and 3a also in an imaginary adjustment plane that comprises the adjustment axis S. The obstruction portion 1050 can also be referred to as a shut-off portion.

The interior 104 corresponds to a wet side of the inner body 100. A dry side is located outside the inner body 100. In the open state of the valve portion 1000, there is a free space between the seat portion 1010 and the obstruction portion 1050, which is filled with process fluid during operation. The interior 104 of the inner body 100 is in contact with the media during operation. This means that in the interior 104, during operation, the process fluid is provided by means of the valve portion 1000. The inner body 100 thus separates the outer body 200 from the process fluid or process medium. In other words, during operation, the inner body 100 is located between the process fluid and the outer body 200.

The valve portion 1000 comprises an intermediate portion 1200, which connects the seat portion 1010 to the movable obstruction portion 1050 in one piece and in a material-fitting manner, wherein the seat portion 1010, the obstruction portion 1050 and the intermediate portion 1200 delimit the common interior 104 with their corresponding inner surfaces at least in portions. For example, the intermediate portion 1200 and the obstruction portion 1050 are made of the same material.

A wall of the inner body 100, the surface of which delimits the interior 104, is continuous, i.e., manufactured from a single material between the process fluid ports 1900 and their openings leading into the interior 104.

It is shown that at least the seat surface 1012 and in particular the obstruction surface 1052 of the at least one valve portion 1000 deviate from a shape of a cylinder jacket, which follows a portion adjacent to the valve portion 1000 and its inner contours.

Due to a movement of the obstruction portion 1050 towards the seat portion 1010, the obstruction surface 1052 moves towards the stationary seat surface 1012 during operation, in order to reduce the flow of process fluid through the valve portion 1000. Due to a movement of the obstruction portion 1050 away from the stationary seat portion 1010, the obstruction surface 1052 moves away from the seat surface 1012 and increases the flow of process fluid through the valve portion 1000.

The inner body 100 is manufactured in an open or partially open position of the valve portion 1000. Of course, the inner body 100 can also be manufactured in another intermediate position of the obstruction portion 1050 to the seat portion 1010, which is stationary during operation, wherein the intermediate position is located between the open position and the closed position.

At least the obstruction portion 1050 or at least an adjacent portion is designed to be flexible. Although the seat portion 1010 can also be designed to be flexible, during operation it is pressed against an inner wall of the outer body 200 by the fluid pressure and is thus stationary during operation.

FIG. 1a specifically shows an example of the inner body 100 having a plug diaphragm-type valve portion 1000. The seat surface 1012 surrounds and delimits an inner fluid opening 1014, which can be closed by means of the obstruction surface 1052 that can be pressed onto the seat surface 1012. In the example shown, an adjacent fluid channel of the port 1900a meets the adjustment axis S with its central longitudinal axis M perpendicularly. The adjustment axis S in turn defines with the seat portion 1010 the port region for a further fluid channel towards the port 1900b. The further fluid channel of the port 1900b bends by 90° in order to run parallel to the fluid channel of the port 1900a with the central longitudinal axis M.

For example, it is shown that the seat surface 1012 and the obstruction surface 1052 of the at least one valve portion 1000 are in each case rotationally symmetrical to the adjustment axis S. The seat surface 1012 follows a circular shape and delimits the fluid opening 1014 for the flow of process fluid. For example, the seat surface 1012 follows a truncated cone or a circular ring shape.

For example, it is shown that the obstruction portion 1050 extends in its longitudinal extent along the adjustment axis S and, facing away from the seat portion 1010, is connected to a flex portion 1056. The flex portion 1056 connects the obstruction portion 1050 in a movable form, so that it is movable along the adjustment axis S. The flex portion 1056 integrally connects the obstruction portion 1050 to the remaining inner body 100. The flex portion 1056 is part of intermediate portion 1200.

It is shown that the obstruction portion 1050, with its outer cross section oriented towards the interior 104, tapers at least in portions away from the seat portion 1010, wherein the flex portion 1056 adjoins the taper 1059. A working space 1004 is enlarged accordingly. The working space 1004 of the valve portion 1000 is part of the interior 104 and extends to the adjacent portions of the valve portion 1000. The flex portion 1056 is designed to be rotationally symmetrical to the adjustment axis S. The obstruction portion 1050 is designed to be projection-like and protrudes into the working space 1004 of the valve portion 1000. The obstruction portion 1050 is arranged so as to be movable along the adjustment axis S within the working space 1004 of the valve portion 1000 and is surrounded by process fluid during operation.

In at least one movement state, the flex portion 1056 follows, at least in portions, a torus shape having an assigned center circle 1060. The flex portion 1056 ensures that, on the one hand, the obstruction portion 1050 can move along the adjustment axis S. On the other hand, the flex portion 1056 connects the obstruction portion 1050 to remaining inner body 100. Of course, the flex portion can also follow a shape other than a torus shape.

The distal surface of the obstruction portion 1050, which also comprises the obstruction surface 1052, is designed to be continuous, convex and substantially rotationally symmetrical to the adjustment axis S. Starting from the initially widening convex distal surface in the proximal direction and a rounded edge 1082, the obstruction portion 1050 tapers towards the flex portion 1056.

FIGS. 1d and 2e show the 2-part outer body 200 in an open position. The two half-shells 202 and 204 together define a negative contour to the outer contour of the inner body 100. The negative contour thus comprises process fluid port support portions 2900a-b, a support portion 2000 for the valve portion 1000 and a support portion 2800 for the connecting portion 1800. The rigid inner negative contour of the multi-part outer body 200 to the outer contour of the inner body 100 thus not only forms a receptacle for the inner body 100, but also a rigid support contour as a counter-bearing for the inner body 100 subjected to media pressure.

An adjustment opening 2002 connects the interior of the outer body 200 with an exterior of the outer body 200 and extends along the adjustment axis S. A drive rod 902 of the drive 900 or a corresponding extension, which drive rod is movable along the adjustment axis S, is guided through the adjustment opening 2002.

In the example of FIG. 1d, the negative contour comprises a support portion 2800 for the connecting portion 1800.

A rigid seat support contour 2012 of the outer body 200 is rotationally symmetrical to the adjustment axis S and forms a contact surface and counter-surface for the seat portion 1010 of the inner body 100. If the obstruction portion 1050 moves towards the seat portion 1010, the seat portion 1010 is compressed between the obstruction portion 1050 and the rigid support contour 2012, in order to close the valve portion 1000 or to seal it inwards.

A rigid flex support contour 2056 supports the flex portion 1056 of the inner body 100 and forms a counter-bearing for the abutment in portions of the flex portion 1056.

FIG. 1e shows the example of process valve 2 from FIG. 1c. The half-shells 202 are assembled and form the outer body 200, in which the inner body 100 is arranged. A screw connection 206 connects the two half-shells 202 and 204. Furthermore, an intermediate part 4 is provided, which fixes the half-shells 202 and 204 on the drive side by means of screw connections 6 and 8. Of course, a type of hinge and a quick-release fastener in a form not shown can also connect the half-shells 202 and 204 together.

FIGS. 1c, 8a, 9a and 11a show the arrangement of a compressor 1070. The compressor 1070 has a higher modulus of elasticity than the obstruction portion 1050 and is arranged on the dry side within the obstruction portion 1050, at least in portions. The compressor 1070 abuts, at least in portions, on the outer wall of a blind hole accessible from the dry side of the inner body 100. The compressor 1070 comprises a drive-side interface 1072 that is designed, for example, as an inner thread, for arranging a drive rod 902 or an intermediate element.

An outer diameter of the compressor 1070 of FIGS. 8a, 9a and 11a increases along the adjustment axis S in the direction of the seat portion 1010. The compressor 1070 is fixed in a form-fitting manner within the obstruction portion 1050.

FIGS. 1c, 2c, 2d and 11c show a process valve or valve assembly 2 having the inner body 100 and the rigid multi-part outer body 200, wherein the rigid outer body 200 has the counter-contour 220 to the outer contour 102 of the inner body 100, wherein the inner body 100 is received in a form-fitting manner in the counter-contour 220. At least one drive 900 is arranged rigidly on the outer body 200, wherein the drive rod 902 of the at least one drive 900, which drive rod is movable along the adjustment axis S, protrudes through the assigned adjustment opening 2002 of the outer body 200 and is connected in a force-transmitting manner to the obstruction portion 1050 of the assigned at least one valve portion 1000.

FIGS. 1a, 2a and 3a show that the obstruction portion 1050 has a dry-side coupling portion 1054 for force-transmitting connection with a drive-side counter-coupling portion 952. The obstruction portion 1050 comprises a dry-side undercut 1062 for form-fitting engagement of a drive-side counter-coupling portion 952. A projection 1064 delimiting the undercut 1062 is made, for example, of a flexible material such as an elastomer material, in order to snap into a corresponding recess of the counter-coupling portion 952 when the counter-coupling portion 952 is advanced. A pressure piece or the compressor snaps into the counter-contour of the coupling portion 1054.

In the example of FIG. 1a-c, the projection 1064 is designed to be axially symmetrical to the adjustment axis S. In another example, the projection 1064 can also be rotationally symmetrical to the adjustment axis S. The counter-coupling portion 952 has a recess that has at least one circular opening through which the projection 1064 passes in order to be fixed to the counter-coupling portion 925.

In the examples of FIG. 2a-c and 3a-c, the projection 1064 follows, in portions, an outer cylinder surface whose cylinder axis runs perpendicular to the adjustment axis S and in a plane of the fluid path P. Furthermore, the projection 1064 tapers towards the adjustment axis S in that boundary surfaces running skewed to the cylinder axis form end surfaces pointing away from one another. Thus, the projection 1064 tapers along its longitudinal extent towards the adjustment axis S. The counter-coupling portion 925 has a counter-contour matching the projection 1064 in the form of a laterally open inner cylinder.

FIGS. 1a, 9a and 9b in each case show the arrangement of an outer support portion 1016, i.e., one arranged to the outside with respect to the inner body 100. The inner body 100 comprises at least one support portion 1016, which adjoins the seat portion 1010 towards the outside and which has an increased modulus of elasticity relative to the seat portion 1010.

FIGS. 1a and 9b show the inner body 100 having an outer contour that has no acute angles, at least in the regions where the inner body 100 abuts against the assigned outer body. For example, it is shown that a recess facing to the outside of the seat portion 1010 has a plurality of acute angles, and that the recess is closed with the support portion 1016. The support portion 1016 is connected in a material-fitting manner to the seat portion 1010, for example glued or printed into one another, i.e., additively manufactured.

In particular, in the case of FIG. 1a and in other examples, the support portion 1016 can also be omitted if the inner body 100 is arranged in the outer body 200 according to FIG. 1c-e. The process fluid port 1900b is connected to the valve portion 1000 via a fluid-carrying connecting portion 1800. The process fluid port 1900a is directly connected to the valve portion 1000.

FIGS. 2a and 3a specifically show an example of the inner body 100, the valve portion 1000 of which has a flow behavior comparable to a diaphragm valve.

It is shown in FIGS. 2c and 3c that at least in an open state of the at least one valve portion 1000, the seat surface 1012 and the obstruction surface 1052, in particular perpendicular to the imaginary flow path P, delimit a clear inner cross-section that is larger perpendicular to the adjustment axis S than along the adjustment axis S. At least in an open state of the at least one valve portion 1000, the seat surface 1012 and the obstruction surface 1052 of the at least one valve portion 1000 run convexly, at least in portions, in a section perpendicular to the imaginary flow path P. The course of the seat surface 1012 or its contour and the course of the obstruction surface 1052, in particular its contour, are web-like and follow an imaginary plane encompassing the adjustment axis S and perpendicular to the fluid path P.

The clear interior 104 widens at least in portions, in particular continuously, in a first longitudinal section perpendicular to the adjustment axis S towards the seat portion 1010, wherein the clear interior 104 tapers at least in portions, in particular continuously, in a second longitudinal section according to FIG. 2a or 3a, in which the adjustment axis S runs, towards the seat portion 1010.

The seat portion 1010 and in particular the seat surface 1012 are designed to be raised relative to the adjacent portions such as the process fluid ports in the interior. The obstruction portion 1050 and the obstruction surface 1052 are not raised or are less raised in relation to the interior 104 and comprise a continuous contour change towards the adjacent portions in the unloaded state. This contour change comprises, starting from the obstruction surface 1052 towards the portion adjacent to the obstruction portion 1000, an increase in the degree of curvature in the corresponding section perpendicular to the fluid path P.

The seat portion 1010 is arranged with its outer surface 1020 offset in the direction of the assigned obstruction portion 1050 relative to an imaginary plane 1022, which abuts tangentially against the portions adjacent to the valve portion 1000, for example process fluid ports 1090.

In other words, the seat, in particular the seat surface 1012, runs in a web-like manner and lies in an imaginary plane in which the adjustment axis S lies, and which runs perpendicular to the fluid path P. As can be seen in FIGS. 2c, 3c, the seat follows a concave curve that lies in the aforementioned imaginary plane. In the longitudinal section according to FIGS. 2a, 3a, the seat-side inner wall comprises an elevation and in the cross section according to FIGS. 2c, 3c, the seat-side inner wall comprises a depression.

In other embodiments (not shown), the seat can comprise multiple changes in curvature in the imaginary plane in which the adjustment axis S lies and which runs perpendicular to the fluid path P.

In the example of FIG. 2e, the mold half 202 comprises the slot-shaped adjustment opening 2002. A recess 2064 delimiting the interior of the outer body 200 crosses the adjustment opening 2002 perpendicular to its course and is designed for receiving the projection 1064.

According to FIG. 3a, the inner body 100 is made of a flexible primary material, in particular an elastomer, at least in a proximal region between the two ports 1900a, 1900b, in particular in one piece. It is shown that the flexible obstruction portion 1050 is held on a holding portion 1300 of the inner body 100, which is rigid, in particular less flexible, compared to the obstruction portion 1050. A fastening portion 1066a, 1066b, which is tubular, at least in portions, protrudes from the obstruction portion 1050 and is received in the holding portion 1300. The fastening portion 1066a, 1066b is held in particular by a form fit within the holding portion 1300. The seat portion 1010 is received in the less flexible holding portion 1300 and its support portion 1016 and terminates flush with the holding portion 1300 towards the interior. The seat portion 1010 and the obstruction portion 1050 are jointly structured from the primary material, whereas the holding portion 1300 is structured from a secondary material.

The inner body 100 is structured with multiple walls, at least in portions. Inside the inner body 100, it is made of the flexible, elastic primary material. The form fit between the primary material and the rigid material of the holding portion 1300 is separated in portions towards the center—i.e., towards the axis S—and is connected via tooth-like interlocking portions. This supports the material bond and prevents slipping.

As the material, the inner body is elastic and the outer region is rigid, at least in portions.

FIG. 4a is a schematic flow diagram for producing the inner body 100. Within the framework of additive manufacturing, the step 400 comprises the application of a layer in a manufacturing plane. Accordingly, by repeating step 400, the inner body 100 is structured layer by layer or 3D printed.

The method comprises at least one assembling 400, layer by layer, of at least one portion of the inner body 100 according to a digital 3D model MD of the inner body 100 from at least one material, in particular the primary material M1. This assembling, layer by layer, can also be referred to as additive manufacturing or three-dimensional printing. The assembling, layer by layer, comprises, in a step 400, the creation of a layer and, in the subsequent step 400, the application of a further layer onto the previously created layer. Each individual layer can thus comprise a plurality of different functional regions of the inner body 100, wherein the creation of these functional regions in the layering process is explained below. Additive manufacturing is accompanied by design features that are fixed in the 3D model MD and subsequently realized or produced during the manufacturing or printing process.

A 3D printing process can be used as a 3D printing process in which a plurality of plastics of different elasticity are processed simultaneously.

The assembling 400 comprises assembling 402, layer by layer, at least one or a plurality of the valve portions 1000, in each case comprising the seat portion 1010 that is stationary at least during operation and the obstruction portion 1050 that is integrally connected to the seat portion 1010 and opposite the seat portion 1010, wherein the obstruction portion 1050 is movable towards the seat portion 1010 and away from the seat portion 1010 along an adjustment axis S, at least during operation of the valve, in order to change the flow of the process fluid through the valve portion 1000.

The assembling 400 comprises assembling 404, layer by layer, the intermediate portion 1200, which connects the seat portion 1010 to the movable obstruction portion 1050, wherein the seat portion 1010, the obstruction portion 1050 and the intermediate portion 1200 delimit the common interior 104 with their corresponding inner surfaces.

The assembling 400 comprises assembling 406, layer by layer, the at least one support portion 1016, which adjoins the seat portion 1010 on the outside, from the secondary material, which, in the manufactured state, has an increased modulus of elasticity relative to the primary material for the seat portion 1010.

For producing an inner body according to one of FIGS. 1a, 2a and 3a, the assembling 400, layer by layer, comprises: assembling 410, layer by layer, the at least one connecting portion 1800, which delimits the interior 104 and which integrally connects two valve portions 1000 or one valve portion 1000 and a process fluid port 1900.

The assembling 400 comprises assembling 420, layer by layer, a removable support contour 4000, which, after production of the inner body 100, is located in particular within the interior 104 of the inner body 100, and consists of a further, in particular washable, material. The method comprises, after the assembling 400, layer by layer, a removal 520 of the support contour 4000 from the inner body 100, in particular by rinsing the inner body 100 with a liquid. Of course, the support contour 4000 can also be broken out, at least partially.

The assembling 400, layer by layer, comprises assembling 430, layer by layer, the connecting portion 1910 of at least one process fluid port 1900 made of the secondary material for connecting the further fluid line; assembling 432, layer by layer, the inner portion 1920 of the at least one process fluid port 1900, wherein the connecting portion 1910 is fixed at least in a form-fitting manner, in particular additionally in a material-fitting manner, to the inner portion 1920 of the process fluid port 1900 delimiting the interior 104, wherein the inner portion 1920 delimiting the interior 104 is manufactured from the primary material.

In the example shown, the steps 402, 404 and 410 along with 432 are assigned to the primary material M1, i.e., the assigned part of the corresponding layer is manufactured with the primary material M1. The steps 406 and 430 are assigned to the secondary material M2, wherein the assigned part of the corresponding layer is manufactured with the secondary material M2. The steps 420 and 520 are assigned to the support material that is removed after performing the deposition, layer by layer, in the step 400.

As an alternative to the aforementioned steps 406 and 430, these can also be assigned to the primary material, wherein the rigid support portions 406 are manufactured from the primary material M1 over an inner structure that is reinforced relative to adjacent portions. In this case, the secondary material M2 can be omitted. It is thus also possible to realize the support portions 406 in the form of an increased wall thickness.

The primary material M1 has a lower modulus of elasticity than the secondary material M2. For example, the materials M1, M2 are either thermoplastics (or a plurality of thermoplastics) or a single thermoset. In particular, the modulus of elasticity of the primary material M1 is less than 1 and the modulus of elasticity of the secondary material M2 is greater than 1.

In one example, different materials M1, M2, M3 are not used; rather, only a single type of plastics material is used, such as different thermoplastics or various thermosets. The inner body 100 of FIG. 2a is manufactured from an elastic material.

An outer shell or the holding part 1300 of FIG. 3a is designed to be rigid, whereas the inner region of the inner body 100 of FIG. 3a, in particular the obstruction portion 1050, is designed to be elastic.

FIG. 4b shows a production method using a modular system. It is shown that the method comprises: producing 602 a plurality of connecting portions 1800, which delimit the interior of the inner body 100 in portions; and multiple joining 604, at least joining in pairs, in particular welding, in particular laser welding, the plurality of valve portions 1000 and the plurality of connecting portions 1800 to the inner body 100.

In one example, the connecting portions 1800 are at least partially manufactured non-additively, for example from a plastic injection molding process, and the valve portions 1000 are at least partially manufactured from an additive manufacturing method.

In one example, the connecting portions 1800 are at least partially additively manufactured, for example from an additive manufacturing method, and the valve portions 1000 are at least partially manufactured from a non-additive manufacturing method, for example a plastic injection molding process. Thus, additively manufactured valve portions 1000 are initially provided according to step 400 and connecting portions 1800 are provided according to step 602. Both the valve portions 1000 and the connecting portions 1800 can be dimensioned and designed differently and thus form the modular system. In the step 604, the valve portions 1000 and the connecting portions 1800 are joined to the inner body 100 or a base component. Of course, the process fluid ports 1900 are also joined in the step 604 in a form not shown. Alternatively, the process fluid ports 1900 can also be manufactured integrally with one of the elements 1000 and 1800.

FIG. 4c shows an example of the step 400 for producing the inner body 100 or a part thereof according to one of FIGS. 1a, 5, 7a, 7b, 8a, 8b, 9a, 9b. The assembling 440 comprises assembling, layer by layer, the seat portion 1010 with the seat surface 1012, which delimits an inner fluid opening 1014, which can be closed by means of the obstruction surface 1052 that can be pressed onto the seat surface 1012, wherein the seat surface 1012 and the obstruction surface 1052 of the at least one valve portion 1000 are in each case formed rotationally symmetrically to the adjustment axis S. The seat surface 1012 follows a circular shape and delimits the fluid opening 1014 for the flow of process fluid. For example, the seat surface 1012 follows a truncated cone or a circular ring shape.

It is shown that the assembling 400, layer by layer, comprises: assembling 442, layer by layer, the obstruction portion 1050, which extends in its longitudinal extent along the adjustment axis S and, facing away from the seat portion 1010, is connected to a flex portion 1056; assembling 444, layer by layer, the flex portion 1056, wherein the flex portion 1056 connects the obstruction portion 1050 integrally and movably to the remaining inner body 100 along the adjustment axis S. The obstruction portion 1050 tapers, at least in portions, away from the seat portion 1010, wherein the flex portion 1056 adjoins the taper 1059. The flex portion 1056 is designed to be rotationally symmetrical to the adjustment axis S. The obstruction portion 1050 is designed like a projection, protrudes into a working space 1004 of the valve portion 1000 and is arranged so as to be movable along the adjustment axis S within the working space 1004 of the valve portion 1000.

The assembling 400, layer by layer, comprises assembling 446, layer by layer, a compressor 1070, which has a higher modulus of elasticity than the obstruction portion 1050 due to the use of the secondary material, and is arranged on the dry side, at least in portions, within the obstruction portion 1050. The compressor 1070 is connected to the obstruction portion 1050 in a form-fitting and/or a material-fitting manner. Here as well, the assignment of materials M1 and M2 from FIG. 4a applies. The compressor 1070 is designed to be harder than, for example, the obstruction portion 1010.

FIG. 4d shows an example of the step 400 for producing the inner body 100 or a part thereof according to one of FIGS. 2a, 3a, 6, 7a, 7b. The assembling 400, layer by layer, comprises assembling 450, layer by layer, the seat portion 1010, wherein the clear interior 104 widens at least in portions, in particular continuously, in a first longitudinal section perpendicular to the adjustment axis S towards the seat portion 1010, and wherein the clear interior 104 tapers at least in portions, in particular continuously, in a second longitudinal section, in which the adjustment axis S runs, towards the seat portion 1010.

At least in an open state of the at least one valve portion 1000, the seat surface 1012 and the obstruction surface 1052, in particular perpendicular to the imaginary flow path P, delimit a clear inner cross section that is larger perpendicular to the adjustment axis S than along the adjustment axis S.

The corresponding course of the seat surface 1012 and the obstruction surface 1052 are web-like and run in or follow an imaginary plane encompassing the adjustment axis S.

It is shown that the assembling 400, layer by layer, comprises: assembling 452, layer by layer, the flexible obstruction portion 1050; assembling 454, layer by layer, the holding portion 1300 of the inner body 100, which is rigid compared to the obstruction portion 1050, wherein the flexible obstruction portion 1050 is held on the holding portion 1300, and wherein the modulus of elasticity of the obstruction portion 1050 is smaller than the modulus of elasticity of the holding portion 1300.

FIG. 5 is a perspective view of an example of the inner body 100. In the example, it is shown that the inner body 100 comprises: a plurality of valve portions 1000 having the corresponding seat portion 1010 that is stationary at least during operation but also in an unloaded state, and having the obstruction portion 1050 that is integrally connected to the seat portion 1010 and opposite the seat portion 1010, wherein the corresponding obstruction portion 1050 is movable, at least during operation, towards the seat portion 1010 and away from the seat portion 1010 along an adjustment axis S, in order to change the flow of the process fluid through the valve portion 1000; and a plurality of connecting portions 1800, wherein the plurality of valve portions 1000 and the plurality of connecting portions 1800 are at least partially connected to one another in pairs to form the inner body 100. The valve portions 1000a+b are structured analogously to the valve portions 1000 from FIG. 1a-c. The connecting portions 1800a+b are in each case structured as a portion of a Tesla valve.

FIG. 6 shows an inner body 100 with a plurality of valve portions 1000a-e structured in the manner of diaphragm valves. The structure is explained in more detail below using the valve portion 1000c as an example. The obstruction portion 1050c is additively manufactured together with the assigned seat portion 1010c. A fluid port 1900c is manufactured by means of an injection molding process. The valve portion 1000c and the fluid port 1900c are joined at a connecting seam 1080c, for example by means of laser welding.

FIGS. 7a and 7b show an inner body 100 with differently shaped valve portions 1000x according to FIGS. 1a, 1000y according to FIG. 2a and a further valve portion 1000z, the interior of which has a plurality of chambers separated from one another in cross section. The valve portion 1000y abuts perpendicularly on the connecting portion 1800y, wherein an opening into the connecting portion 1800x is delimited by the obstruction portion 1050y and the seat portion 1010y. Thus, dead spaces are reduced and the inner body 100 is compacted. The chambers of the valve portion 1000z are delimited in pairs by separation walls 1080 and the inner wall of the valve portion 1000z. The valve portion 1000z is compressed along the adjustment axis Sz, as a result of which the valve portion 1000z is closed. In the present case, the valve portion 1000z can be compressed and opened from both sides along the adjustment axis Sz, i.e., there are two opposite drives. Alternatively, the valve portion 100z is operated from one side only with a single drive.

FIG. 8a shows the inner body 100 having a common channel portion 180, which, like the compressors 1070, is manufactured from the secondary material with a larger modulus of elasticity than the primary material of a corresponding attachment portion 190. An attachment portion 190 partially comprises the features analogous to the valve portion 1000 from FIG. 1a. In contrast to FIG. 1a, the corresponding valve portion 1000 comprises a rigid seat portion 1010, for example made of the secondary material, and the elastic obstruction portion 1050, for example made of the primary material. Although the corresponding inner compressor 1070 is designed to be rigid, it is surrounded by an elastic portion on the fluid side. The elastic portion surrounding the inner rigid compressor 1070 meets a rigid valve seat in the sense of the seat surface 1012. Thus, a hard-soft seal is realized.

Furthermore, in the example of FIG. 8b, a portion 192 of the attachment portion 190 protrudes into the material of the channel portion 180 and fixes the attachment portion 190 to the channel portion 180 not only in a material-fitting manner, but also in a form-fitting manner.

In contrast to FIG. 8a, the inner body 100 from FIG. 9a with its inner wall is manufactured from the primary material with a lower modulus of elasticity. The secondary, harder material is used for the support structures 1016 and the compressors 1070. In this example, the corresponding inner compressor 1070 is designed to be rigid and the outer support portions 1016 are in each case designed to be rigid. Inwards, elastic portions of the inner body 100 adjoin the compressor 1070 and the support portions 1016. Thus, an inner soft-soft seal is provided. FIG. 9b shows the inner body 100 with a plurality of valve portions 1000 analogous to that of FIG. 1a. A plurality of connecting portions 1074 are rigidly connected to a corresponding non-visible compressor, in particular with an outer thread screwed into an inner thread of the compressor. The connecting portions 1074 comprise a corresponding dry-side distal coupling portion 1054 and a support portion 1066.

FIGS. 10a and 10b show the process fluid ports 1900a-b of the inner body 100, wherein one or more valve portions 1000 and connecting portions located therebetween can be located between the ports 1900 shown. The connecting portion 1910 is manufactured from the secondary material for connecting a further fluid line, wherein the connecting portion 1910 is fixed at least in a form-fitting manner, in particular additionally in a material-fitting manner, to an inner portion 1920 of the process fluid port 1900 delimiting the interior 104, wherein the portion 1920 delimiting the interior 104 is manufactured from the primary material.

The portion 1920 comprises freestanding webs 1922 that extend in a circumferential direction, face the outside and run parallel to the fluid path P, and are arranged between two surfaces 1924 and 1926 facing one another. The surfaces 1924 and 1926 run perpendicular to the imaginary fluid path P. The webs 1922 are spaced apart from one another in pairs in the circumferential direction. A surface 1928 extending in the circumferential direction is offset inwardly and arranged in a manner spaced apart from the webs 1922.

Distally, the portion 1920 has a sealing contour 1930 with an annular groove for coupling to a fluid line and sealing the fluid line to the outside. The sealing contour 1930 surrounds an opening 1932, which leads into the interior 104 of the inner body 100.

The webs 1922 and the surfaces 1924, 1926 and 1928 delimit a space that is filled by the secondary material of the connecting portion 1910. Thus, the connecting portion 1910 is fixed in all spatial directions to the portion 1920 and thus to the inner body 100. FIG. 10b shows that the web 1922a and an inner wall 1932a of the portion 1920 delimiting the interior 104 fix a sub-portion 1912a of the connecting portion 1910 to the inner body 104 in a manner resistant to pull-out. Distal and proximal contours 1940 and 1950 between the connecting portion 1910 and the inner portion 1920 improve the stability of the connection between the connecting portion 1910 and the inner portion 1920. Advantageously, only a single plastics material has contact with the process medium, as a result of which a hermetically sealed interior is created. The one-piece design of the inner body 100 also prevents leaks.

FIG. 11a shows an example of the valve assembly 2, which comprises: an inner body 100 and a plurality of first coupling portions 1054, which in each case are connected in a force-transmitting manner to the assigned obstruction portion 1050 of the corresponding valve portion 1000; an outer body 200 designed for receiving the inner body 100 and a plurality of drives 900 rigidly fastened to the outer body 200, wherein at least one second coupling portion 954 is arranged on the corresponding drive rod 902 of the assigned drive 900, wherein a locking element 990 movably arranged within the outer body 200 in an assembly position releases the movement of the first and second coupling portions 954, 1054, which are assigned in pairs, and wherein the locking element 990 in an operating position different from the assembly position connects in a force-transmitting manner the first and second coupling portions 954, 1054, which are assigned in pairs, to one another. In FIG. 11a, the locking element 990 is in the assembly position.

The outer body 200 provides a receiving space 992 in which the locking element 990 is fixed in the outer body 200 so as to be displaceable perpendicular to the adjustment axis S. The receiving space 992 passes through the corresponding adjustment opening 2002 of the outer body 200. In other words, the receiving space 992 is formed by a plurality of sub-spaces that connect adjacent adjustment openings 2002 with one another.

It is shown that at least one locking contour 994 of the locking element 990, in the operating position of the locking element 990, presses the corresponding first coupling portion 954, at least in portions, into the assigned second coupling portion 1054, which is designed in portions as an annular groove. The circular groove of the second coupling portion 1054 runs perpendicular to the adjustment axis S.

For example, it is shown that at least one release contour 996 of the locking element 990 releases an outer contour of the first coupling portion 954 in the assembly position of the locking element 990, so that the first coupling portion 954 moves out of the second coupling portion 1054. The release contour 996 and the locking contour 994 delimit an assigned common through-opening.

The first coupling portion 954 is designed as a quick-lock mechanism, is manufactured from a rigid material, for example, and engages in the outer groove in the sense of the second coupling portion 1054 by the application of force by means of the locking contour 994. Alternatively, the coupling between drive and compressor can also be realized via a connection according to FIG. 1a-c.

It is shown that the locking element 990 has an outer or externally accessible locking surface 991, by means of which the locking element 990 is displaceable into its operating position. The locking element 990 comprises an outer or externally accessible unlocking surface 993, by means of which the locking element 990 is displaceable into its assembly position. The unlocking surface 993 and the locking surface 991 point away from one another.

The support portion 1066 rigidly connected to the dry-side coupling portion 1054 is provided for supporting the flex portion 1056, which is supported by the support portion 1066 in at least one position of the obstruction portion 1050 along the adjustment axis S. The support portion 1066 is in particular designed to be convex and rotationally symmetrical to the adjustment axis S and follows a contour of the flex portion 1056 in portions. In particular, in an open position of the obstruction portion 1050, the flex portion 1056 abuts, at least in portions, against the support portion 1066 with its dry-side surface.

The locking element 990 is manufactured additively together with the outer body 200.

FIG. 11d shows that the plurality of drives 900 are rigidly arranged on the first half-shell 202 of the outer body 200, wherein the second half-shell 204 of the outer body 200, which in particular does not comprise any drives, i.e., is drive-free, together with the first half-shell 202 delimits an inner contour for the form-fitting reception of the inner body 100.

It is shown that the second half-shell 204 is fastened in a captive manner to the first half-shell 202 via a hinge portion 210. The hinge portion 210 comprises, for example, portions protruding from the first half-shell 202 with corresponding elongated holes into which pins of the second half-shell 204 engage. A plurality of through-openings 212 in the second half-shell 204 make possible the passage of a corresponding screw, which can be screwed into an assigned inner thread 214 of the first half-shell 202 or a nut. Alternatively, a quick-release fastener (not shown) can be used for connecting the two half-shells 202 and 204 on the opposite side of the hinge. 3. The inner body 100 is thus secured in the outer body 200 via the quick-lock mechanism. The two half-shells 202, 204 are secured together via the quick-release fastener, e.g. by a plurality of snap connections.

FIGS. 11b and 11c provide a view of the adjustment opening 2002a, wherein the locking element 990 is in the assembly position in FIG. 11b and in the operating position in FIG. 11c. Starting from the assembly position, the locking element 900 reduces the space around the corresponding coupling portion 1054, which is rotationally symmetrical to the adjustment axis S, when displaced into its operating position, in order to introduce a coupling force into the coupling portion 994 from the outside.

FIG. 11d shows the open outer body 200 with the half-shells 202 and 204 from FIG. 11a. The inner body 100 is still arranged in the half-shell 202. For replacing the first inner body 100 with a second inner body 100 within the valve assembly 2, the following steps are performed: the fluid ports of the inner body 100 arranged in the outer body 200 are separated from corresponding pipe or hose portions. After opening the multi-part outer body 200, the locking element 990 is moved into the assembly position for the simultaneous unlocking of the first and second coupling portions 925, 1052, which are assigned in pairs. After removing the first inner body 100 from the outer body 200, the second inner body 100 is arranged in the open outer body 200. Due to a movement of the locking element 990 into the operating position, a locking action of the first and second coupling portions 925, 1052, which are assigned in pairs, takes place, whereby the second inner body 100 is secured against falling out. Subsequently, the outer body 200 can be closed again and the second inner body 100 is held in a form-fitting manner in the outer body 200. The fluid ports of the second inner body 100 are connected to the corresponding pipe or hose portions.

1-59. (canceled)

60. An inner body for controlling a process fluid, wherein the inner body is adapted to be detachably arranged in an outer body, the inner body comprising at least one valve portion arranged along an imaginary flow path between at least two process fluid ports of the inner body, the valve portion comprising:
a seat portion that is stationary during operation and has a seat surface delimiting an interior of the inner body; and
an obstruction portion that is connected to and opposite the seat portion, the obstruction portion having an obstruction surface delimiting the interior of the inner body and being movable, at least during operation and at least in part, along an imaginary adjustment axis toward and away from the seat surface.

61. The inner body of claim 60, wherein the valve portion further comprises an intermediate portion connecting the seat portion to the movable obstruction portion, and wherein the seat portion, the obstruction portion, and the intermediate portion together define the interior of the inner body with their respective inner surfaces.

62. The inner body of claim 60, wherein a wall of the inner body that defines the interior surface is made entirely from a single material.

63. The inner body of claim 60, wherein at least the seat surface and the obstruction surface of the valve portion deviate from a cylindrical jacket shape.

64. The inner body of claim 60, wherein the inner body comprises at least one support portion adjoining the seat portion and having a greater modulus of elasticity than the seat portion.

65. The inner body of claim 64, wherein a recess of the inner body delimited by the seat portion is closed with the support portion.

66. The inner body of claim 60, wherein the obstruction portion comprises a dry-side coupling portion configured for force-transmitting connection to a drive-side counter-coupling portion.

67. The inner body of claim 60, wherein at least one of the process fluid ports comprises an outer connecting portion made of a secondary material for connection to a fluid line, the outer connecting portion being fixed at least in a form-fitting manner to an inner portion of the process fluid port delimiting the interior, the inner portion being made from a primary material having a lower modulus of elasticity than the secondary material.

68. The inner body of claim 60, wherein the seat surface defines an inner fluid opening that can be closed by the obstruction surface.

69. The inner body of claim 60, wherein the seat surface and the obstruction surface are rotationally or axially symmetrical relative to the adjustment axis.

70. The inner body of claim 60, wherein the obstruction portion extends longitudinally along the adjustment axis and is connected at an end facing away from the seat portion to a flex portion that connects the obstruction portion to the remainder of the inner body in a movable and integral manner.

71. The inner body of claim 70, wherein the obstruction portion tapers in a direction away from the seat portion, and the flex portion adjoins the taper.

72. The inner body of claim 70, wherein the flex portion is rotationally symmetrical with respect to the adjustment axis.

73. The inner body of claim 60, wherein the obstruction portion is projection-shaped, protrudes into a working space of the valve portion, and is movable along the adjustment axis within the working space.

74. The inner body of claim 60, wherein a compressor is arranged at least in part on a dry side within the obstruction portion and has a higher modulus of elasticity than the obstruction portion.

75. The inner body of claim 60, wherein a support portion rigidly connected to the dry-side coupling portion supports the flex portion in at least one position of the obstruction portion along the adjustment axis.

76. The inner body of claim 60, wherein in an open state of the valve portion, the seat surface and the obstruction surface define a clear cross section that is larger perpendicular to the adjustment axis than along the adjustment axis.

77. The inner body of claim 60, wherein in an open state of the valve portion, the seat surface and the obstruction surface each run convexly, at least in part, in a cross section perpendicular to the imaginary flow path.

78. The inner body of claim 60, wherein the seat surface and the obstruction surface have a web-like shape in an imaginary plane encompassing the adjustment axis.

79. The inner body of claim 60, wherein the interior widens, at least in part and continuously, in a first longitudinal section perpendicular to the adjustment axis toward the seat portion, and wherein the interior tapers, at least in part and continuously, in a second longitudinal section along the adjustment axis toward the seat portion.

80. The inner body of claim 60, wherein the obstruction portion is held on a holding portion of the inner body that is rigid or less flexible relative to the obstruction portion.

81. The inner body of claim 60, wherein the seat portion has an outer surface recessed relative to an imaginary plane that tangentially abuts portions adjacent to the valve portion.

82. A process valve or valve assembly comprising:
an inner body according to claim 60; and
a rigid, multi-part outer body having a counter-contour to an outer contour of the inner body, wherein:
the inner body is received in the counter-contour in a form-fitting manner;
at least one drive is rigidly arranged on the outer body; and
a drive rod of the at least one drive, the drive rod being movable along the adjustment axis, protrudes through an adjustment opening of the outer body and is connected in a force-transmitting manner to the obstruction portion of the valve portion of the inner body.
